(19) United States
(12) Patent Application Publication
(10) Pub. No.: US 2005/0262229 A1
(43) Pub. Date: Nov. 24, 2005

(54) Object conduit MIB for communicating over SNMP between distributed objects

(75) Inventors: Balasubrahmanyam Gattu, Garland, TX (US); Michael Hall, Carrollton, TX (US); Kong-Posh Bhat, Plano, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 10/826,879

(22) Filed: Apr. 16, 2004

(51) Int. Cl. G06F 15/173

(52) U.S. Cl. 709/223

(57) ABSTRACT

A first object-oriented telecommunication device that communicates with a second object-oriented telecommunication device in the communication network. The first object-oriented telecommunication device comprises: 1) a plurality of objects executable by processing circuitry associated with the first object-oriented telecommunication device; and 2) an object conduit management information base (MIB) manager for gathering data from one or more of the plurality of objects and generating therefrom a management information base (MIB) data structure suitable for communicating with the second object-oriented telecommunication device using a specified protocol interface, such as Simple Network Management Protocol (SNMP).

### TECHNICAL FIELD OF THE INVENTION

The present invention relates generally to telecommunication systems and, more specifically, to a technique for communicating over SNMP between distributed objects in an object-oriented system.

### BACKGROUND OF THE INVENTION

In a distributed object-oriented telecommunication system, the technique used to communicate between objects depends on the location of the objects. If two communicating objects are within the same process, direct object-to-object method invocation is typically used. Thus, Object A invokes a method directly on Object B. A method may be, for example, changing a power parameter in Object B. This is the simplest and purest form of object-oriented communication, since it preserves the object-oriented model within the application code.

Objects residing in different processes within the same telecommunication device may use several different techniques to communicate, including inter-process communication (IPC), shared memory, sockets, message queues, and semaphores. However, objects residing in different processes running on different telecommunication devices require a unique approach, since system resources are not shared across platforms. One commonly used communication technique is the common object request broker architecture (CORBA). However, CORBA is not widely used in embedded systems because of its inherent performance overhead and the project risk in introducing this new technology.

In conventional telecommunication systems, the Simple Network Management Protocol (SNMP) is commonly used between a management platform and a managed element. The SNMP standard provides an efficient mechanism for communicating between applications. SNMP uses simple primitives, such as “get” and “set” on a defined management information base (MIB) data structure. Another SNMP primitive is “trap” (or “notification”), which may be used to signal an autonomous event from a first device to a second device using the MIB.

However, the SNMP standard is not inherently object-oriented and, as such, does not support direct object-to-object method invocation. Object-to-object communication over SNMP uses a conventional SNMP MIB data structure, which contains data structures representing each managed element, the data attributes of the managed elements, and a restrictive set of supported operations to manipulate the attributes. A conventional SNMP MIB may be used to get or set data attributes within the MIB. To accomplish object-to-object communication this way, extraneous data attributes often must be included within the MIB to notify the recipient object that a requesting object needs to communicate. The receiving object detects the attribute change and quite often must use other data structures within the MIB to ascertain the intent of the communication. This is a cumbersome and inefficient approach to object communication.

The use of the conventional MIB forces the programmer into a relational view of the data, as opposed to preserving the object-oriented view. Object-oriented methods must be translated to another programming paradigm—the relational setting of MIB variables to pre-defined values. Also, conventional MIB traps and notifications must be defined for all types of autonomous messages from the managed element to the management platform.

Object-oriented methods must be forced into a restrictive set of SNMP primitives (SET, GET, TRAP). Many times the inherent expressiveness of the object-oriented program does not fit well into a restrictive set designed for primarily attribute setting and retrieval. The addition of new objects and methods at the management platform requires changes to the conventional MIB structure to accommodate this change, and vice-versa. As system requirements grow, the conventional MIB tends to grow to a significantly large size, often to an unsustainable size.

Therefore, there is a need in the art for improved object-oriented communications in a distributed telecommunication system. In particular, there is a need for an improved technique for direct object-to-object method invocation over SNMP between separate telecommunication devices.

### SUMMARY OF THE INVENTION

The purpose of this invention is to define an “object conduit” MIB for use within SNMP in a way such that the basic object-to-object method invocation model is preserved even when communicating from one machine to another.

To address the above-discussed deficiencies of the prior art, it is a primary object of the present invention to provide, for use in a communication network, a first object-oriented telecommunication device capable of communicating with a second object-oriented telecommunication device in the communication network. According to an advantageous embodiment of the present invention, the first object-oriented telecommunication device comprises: 1) a plurality of objects executable by processing circuitry associated with the first object-oriented telecommunication device; and 2) an object conduit management information base (MIB) manager capable of gathering data from one or more of the plurality of objects and generating therefrom a management information base (MIB) data structure suitable for communicating with the second object-oriented telecommunication device using a specified protocol interface.

According to one embodiment of the present invention, the specified protocol interface is Simple Network Management Protocol (SNMP).

According to another embodiment of the present invention, the MIB data structure comprises an object identifier (ID) associated with a target object in the second object-oriented telecommunication device.

According to still another embodiment of the present invention, the MIB data structure comprises a method name identifying a selected method associated with the target object and at least one method parameter associated with the selected method.

According to yet another embodiment of the present invention, the object conduit MIB manager comprises an interface controller capable of communicating with the one or more of the plurality of objects and gathering the data from the one or more of the plurality of objects.

According to a further embodiment of the present invention, the object conduit management information base (MIB) manager is further capable of receiving a response MIB data structure from the second object-oriented telecommunication device, extracting data from the response MIB data structure, and distributing the extracted data to the one or more of the plurality of objects.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which numerous object-oriented telecommunication devices may communicate via Simple Network Management Protocol (SNMP) using an object conduit Management Information Base (MIB) according to the principles of the present invention;

FIG. 2 illustrates selected object-oriented devices in the exemplary wireless network in FIG. 1 that communicate an object conduit MIB over SNMP according to the principles of the present invention;

FIG. 3 is a message flow diagram illustrating the invocation of a method on a managed element using an object conduit MIB agent according to the principles of the present invention;

FIG. 4 is a message flow diagram illustrating invocation of a method on a managed element using SNMP master agent according to the principles of the present invention;

FIG. 5 is a message flow diagram illustrating the invocation of a method on a management platform using an object conduit MIB agent according to the principles of the present invention;

FIG. 6 is a message flow diagram illustrating the invocation of a method on a management platform using an SNMP master agent according to the principles of the present invention;

FIG. 7 is a message flow diagram illustrating the invocation of a method with response on a managed element using an object conduit MIB agent according to the principles of the present invention; and

FIG. 8 is a message flow diagram illustrating the invocation of a method with response on a managed element using SNMP master agent according to the principles of the present invention.

### DETAILED DESCRIPTION OF THE INVENTION

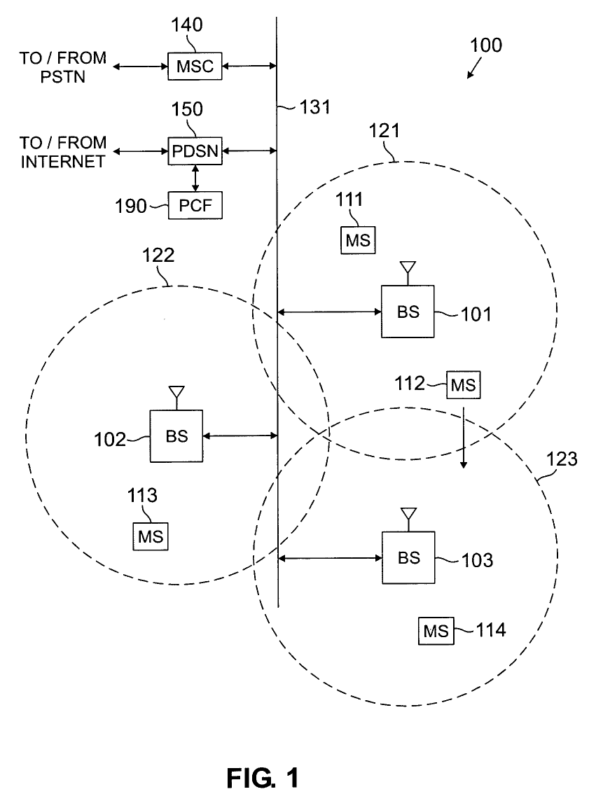

FIGS. 1 through 8, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged telecommunications network.

FIG. 1 illustrates exemplary wireless network 100, in which numerous object-oriented telecommunication devices may communicate via Simple Network Management Protocol (SNMP) using an object conduit Management Information Base (MIB) according to the principles of the present invention. For the purposes of this disclosure and the claims herein, the terms “object-oriented telecommunications device” and “object-oriented device” refer to any device that is capable of executing object-oriented code. Also, the term “object” may refer to a single object or to a plurality of objects.

Wireless network 100 comprises a plurality of cell sites 121-123, each containing one of the base stations, BS 101, BS 102, or BS 103. Base stations 101-103 communicate with a plurality of mobile stations (MS) 111-114 over an air interface. Mobile stations 111-114 may be any suitable wireless devices, including conventional cellular radiotelephones, PCS handset devices, personal digital assistants, portable computers, telemetry devices, and the like, which are capable of communicating with the base stations via wireless links.

The present invention is not limited to mobile devices. Other types of wireless or wireline access terminals, including fixed wireless terminals, may be used. For the sake of simplicity, only mobile stations are shown and discussed hereafter. However, it should be understood that the use of the term “mobile station” in the description below is intended to encompass both truly mobile devices (e.g., cell phones, wireless laptops) and stationary wireless terminals (e.g., monitoring devices with wireless capability).

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

In one embodiment of the present invention, BS 101, BS 102, and BS 103 comprise a base station controller (BSC) and at least one base transceiver subsystem (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystem in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of base stations 101-103, or as a stand-alone device that communicates with PDSN 150, as shown in FIG. 1. Line 131 also provides the connection path to transfer control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, or any other type of data connection. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102 or BS 103 to MSC 140.

In an advantageous embodiment of wireless network 100, various devices in wireless network 100 communicate using object-oriented communication over SNMP. To accomplish this, the present invention provides an object conduit Management Information Base (MIB) data structure for use within the SNMP standard communications. The object conduit MIB preserves the direct object-to-object method invocation model, even between separate telecommunication devices.

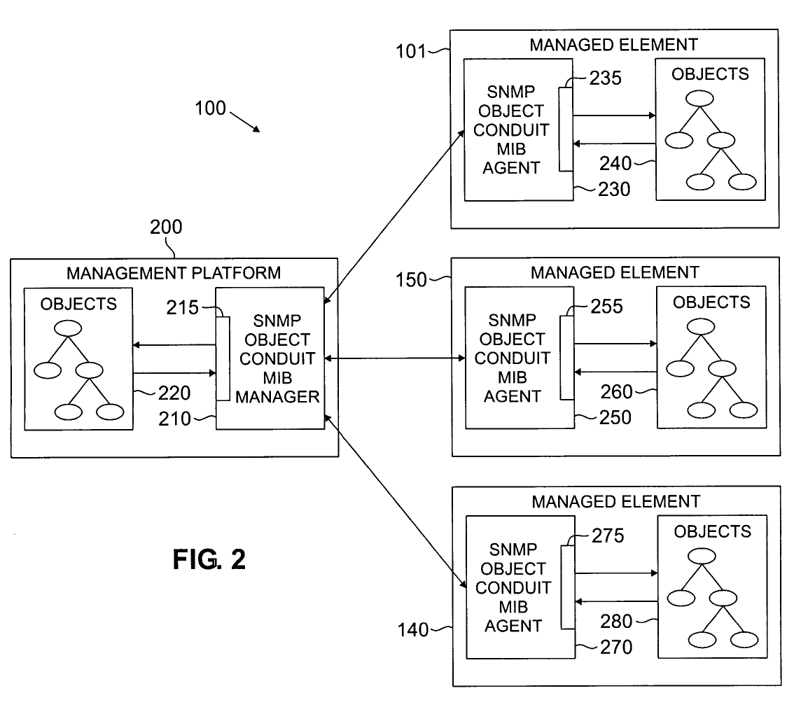

FIG. 2 illustrates selected object-oriented devices in wireless network 100 that communicate an object conduit MIB over SNMP according to the principles of the present invention. Management platform 200 (i.e., a server) communicates with managed elements in three telecommunication devices, namely base station (BS) 101, mobile switching center (MSC) 140, and packet data server node (PDSN) 150. Management platform 200 and the managed elements in BS 101, MSC 140 and PDSN 150 communicate using an object conduit MIB data structure according to the principles of the present invention. The managed elements in BS 101, MSC 140 and PDSN 150 may be referred to hereafter as managed element 101, managed element 140 and managed element 150, respectively.

Management platform 200 comprises objects 220 and Simple Network Management Protocol (SNMP) object conduit MIB manager (OCMM) 210, which includes interface controller 215. According to an advantageous embodiment of the present invention, SCMP OCMM 210 may be implemented as a controller comprising a data processor and executable code stored in memory associated with the data processor. Similarly, interface controller 215 may be implemented as a data processor and executable code stored in memory associated with the data processor. Interface controller 215 communicates with object 220 and is responsible for marshaling and demarshaling object requests.

Managed element 101 comprises objects 240 and Simple Network Management Protocol (SNMP) object conduit MIB agent (OCMA) 230, which includes interface controller 235. According to an advantageous embodiment of the present invention, both SCMP OCMA 230 and interface controller 215 may be implemented as a controller comprising a data processor and executable code stored in memory associated with the data processor. Interface controller 235 communicates with objects 240 and is responsible for marshaling and demarshaling object requests.

Managed element 150 comprises objects 260 and Simple Network Management Protocol (SNMP) object conduit MIB agent (OCMA) 250, which includes interface controller 255. According to an advantageous embodiment of the present invention, both SCMP OCMA 250 and interface controller 255 may be implemented as a controller comprising a data processor and executable code stored in memory associated with the data processor. Interface controller 255 communicates with objects 260 and is responsible for marshaling and demarshaling object requests.

Managed element 140 comprises objects 280 and Simple Network Management Protocol (SNMP) object conduit MIB agent (OCMA) 270, which includes interface controller 275. According to an advantageous embodiment of the present invention, both SCMP OCMA 270 and interface controller 275 may be implemented as a controller comprising a data processor and executable code stored in memory associated with the data processor. Interface controller 275 communicates with objects 280 and is responsible for marshaling and demarshaling object requests.

Objects 220, objects 240, objects 260 and objects 280 comprise many different types of applications that are capable of executing tasks and communicating with one another. Objects 220, 240, 260 and 280 may comprise, for example, applications within the base station controller (BSC) of a base station, a circuit card within the BSC, or a channel element on a circuit card in the BSC.

In network management systems, management platform 100 provides the user interface that allows a network operator to perform management functions. Typical management functions include, for example, configuration of network elements, execution of diagnostics testing, reporting of operational measurements, and reporting of fault conditions within wireless network 100. Management platform 200 ascertains the overall health of wireless network 100 and makes adjustments when necessary.

A managed element is the network component that provides a service within network 100. Examples of managed elements are wireless base stations, controllers, switches, routers, service creation points, protocol converters, and the like. A managed element communicates bi-directionally with the management platform to establish operational values and report faults and measurement data.

As noted above, management platform 200 and managed elements 101, 140 and 150 communicate using an object conduit MIB. The management information base (MIB) data structure represents the agreement between management platform 200 and managed elements 101, 140 and 150 in terms of the supported operations and data structures. The present invention combines object-to-object communication within the SNMP MIB approach. The advantage of this approach is that it preserves the object paradigm for objects communicating on different machines.

The object conduit MIB includes the marshaling and demarshaling capabilities of interface controllers 215, 235, 255 and 275. For the purposes of this patent application, marshaling is defined as the process of gathering data from one or more applications or non-contiguous sources in computer storage (i.e., objects), putting the data pieces into a message buffer, and organizing or converting the data into a format that is prescribed for a particular receiver or programming interface (such as SNMP). Similarly, demarshaling is the process of extracting the data from the message buffer and converting it for use by one or more applications (objects).

In the object conduit MIB approach, the MIB becomes a conduit of information. The structure of the data is in the form of target object IDs, method names for the target objects, and method parameters. The exact content (values) of the information that is being passed along is known only to the communicating objects and is not known at the MIB level. Logic decisions regarding how to interpret the transmitted information are restricted to the two communicating objects.

According to an advantageous embodiment of the present invention, the object conduit MIB data structure is a structure containing the following major attributes: 1) MIB header fields; 2) object ID; 3) method information; 4) method name; 5) number of parameters; 6) method parameters; 7) transaction ID; and 8) object notification. An exemplary MIB structure is shown in the Appendix of this application.

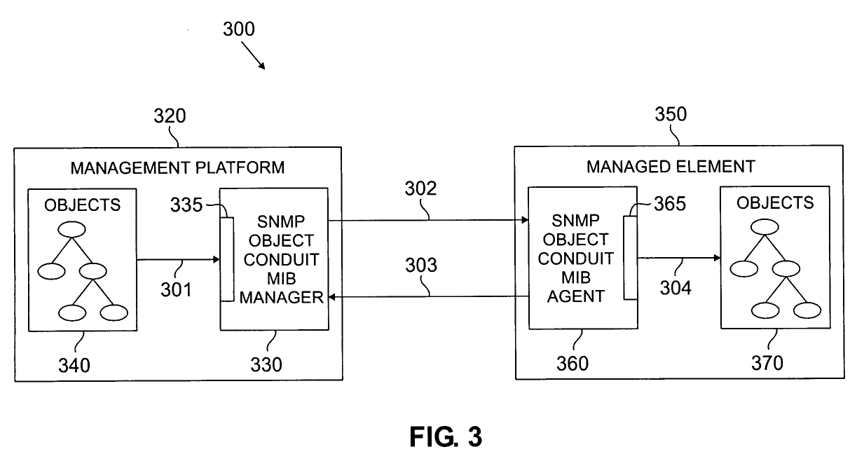

FIG. 3 depicts message flow diagram 300, which illustrates the invocation of a method on managed element 350 using an object conduit MIB agent according to the principles of the present invention. Initially, one of objects 340 in management platform 320 (source) attempts to communicate with one of objects 370 in managed element 350 (target). To do this, the object sends target object ID, target method ID, and target parameters to local SNMP object conduit MIB manager (OCMM) 330 (message 301). Interface software 335 in SNMP OCMM 330 marshals the received information request into an SNMP protocol data unit (PDU) and sends an SNMP Set message to SNMP object conduit MIB agent (OCMA) 360 (message 302).

In response, SNMP OCMA 360 sends an SNMP Set Response message to SNMP OCMM 330 (message 303). The response message indicates the successful delivery of the request to managed element 350. Interface controller 365 in SNMP OCMA 360 demarshals the SNMP PDU into an object request, locates the target object in objects 370, and invokes the specified method on the target object with the designated parameter values. The target object then performs the requested action.

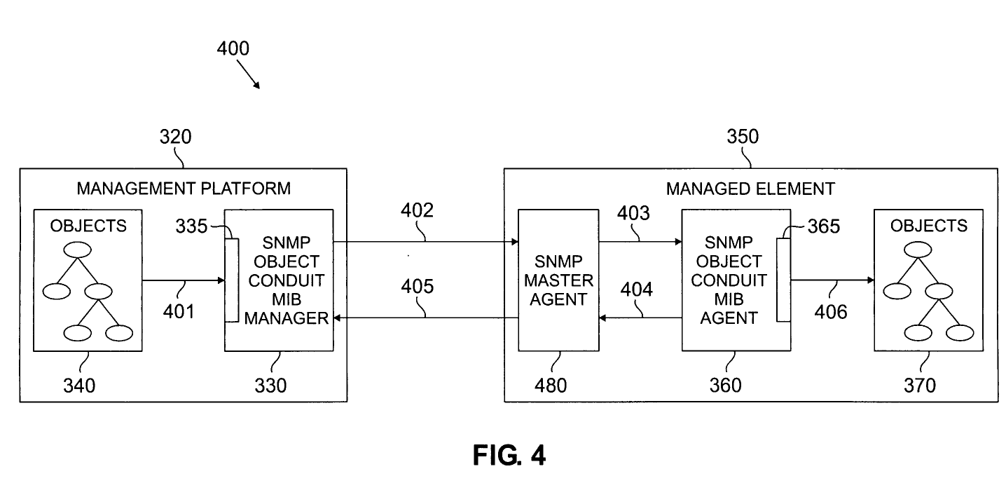

FIG. 4 depicts message flow diagram 400, which illustrates the invocation of a method on managed element 350 using SNMP master agent 480 according to the principles of the present invention. Initially, one of objects 340 in management platform 320 (source) attempts to communicate with one of objects 370 in managed element 350 (target). To do this, the object sends target object ID, target method ID, and target parameters to local SNMP object conduit MIB manager (OCMM) 330 (message 401). Interface software 335 in SNMP OCMM 330 marshals the received information request into an SNMP protocol data unit (PDU) and sends an SNMP Set message to SNMP master agent 480 (message 402).

Next, SNMP master agent 480 identifies SNMP object conduit MIB agent (OCMA) 360 as the sub-agent to which this request belongs and forwards the request to SNMP object conduit MIB agent (OCMA) 360 (message 403). In response, SNMP OCMA 360 confirms receipt of the Set request from SNMP master agent 480 (message 404). SNMP master agent 480 then sends the SNMP Set Response to SNMP OCMM 330 (message 405). This response indicates the successful delivery of the request to managed element 350. Finally, SNMP OCMA 360 demarshals the SNMP PDU into an object request, locates the target object, and invokes the specified method on the target object with the designated parameter values (message 406). The target object performs the requested action.

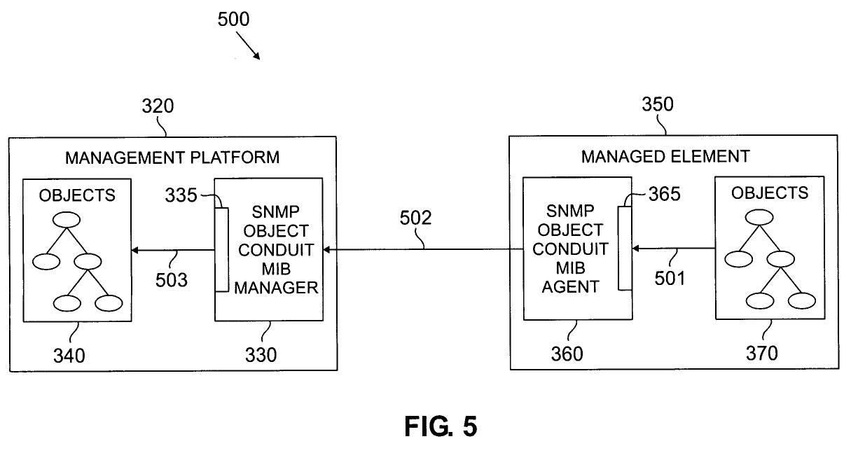

FIG. 5 depicts message flow diagram 500, which illustrates the invocation of a method on management platform 320 using object conduit MIB agent 365 according to the principles of the present invention. Initially, one of objects 370 in managed element 350 (source) attempts to communicate with one of objects 340 in management platform 320 (target). To do this, the object sends target object ID, target method ID, and target parameters to local SNMP object conduit MIB agent (OCMA) 360 (message 501). Interface software 365 in SNMP OCMA 360 marshals the received information request into an SNMP protocol data unit (PDU), constructs a notification message (or trap), and sends the notification message to SNMP object conduit MIB manager (OCMM) 330 (message 502).

In response, interface controller 335 in SNMP OCMM 330 demarshals the SNMP notification message into an object request, locates the target object in objects 340, and invokes the specified method on the target with the designated parameter values. The target object performs the requested action.

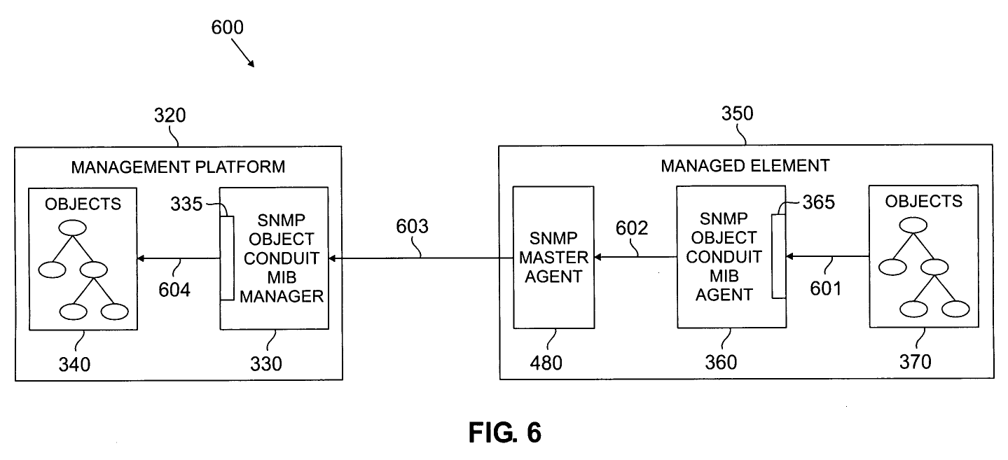

FIG. 6 depicts message flow diagram 600, which illustrates the invocation of a method on management platform 320 using SNMP master agent 480 according to the principles of the present invention. Initially, one of objects 370 in managed element 350 (source) attempts to communicate with one of objects 340 in management platform 320 (target). To do this, the object sends target object ID, target method ID, and target parameters to local SNMP object conduit MIB agent (OCMA) 360 (message 601). Interface software 365 in SNMP OCMA 360 marshals the received information request into an SNMP protocol data unit (PDU), constructs a notification message (or trap), and sends the notification message to SNMP master agent 480 (message 602).

Next, SNMP master agent 480 identifies SNMP object conduit MIB manager 330 as the target of the notification and forwards the notification to SNMP object conduit MIB manager (OCMM) 330 in management platform 320. Interface software 335 in SNMP OCMM 330 demarshals the SNMP notification message into an object request, locates the target object in objects 340, and invokes the specified method on the target object with the designated parameter values. The target object performs the requested action.

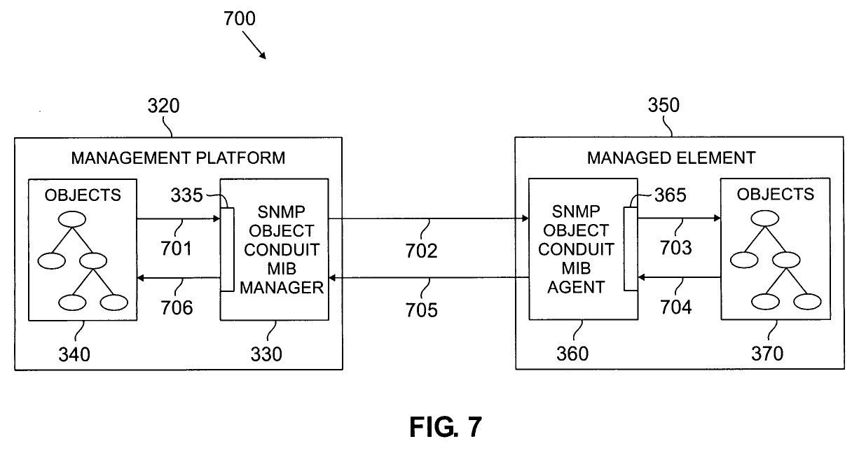

FIG. 7 depicts message flow diagram 700, which illustrates the invocation of a method with response on managed element 350 using SNMP object conduit MIB agent 360 according to the principles of the present invention. Initially, one of objects 340 in management platform 320 (source) attempts to communicate with one of objects 370 in managed element 350 (target). To do this, the object sends target object ID, target method ID, and target parameters to local SNMP object conduit MIB manager (OCMM) 330 (message 701). Interface software 335 in SNMP OCMM 330 marshals the received information request into an SNMP protocol data unit (PDU) and sends an SNMP Set message to SNMP object conduit MIB agent (OCMA) 360 (message 702).

Interface controller 365 in SNMP OCMA 360 demarshals the SNMP PDU into an object request, locates the target object in objects 370, and invokes the specified method on the target object with the designated parameter values (message 703). The target object then performs the requested action. In this scenario, the target object also sends a response message back to the source object. The target object sends the source object ID, response method name, and response parameters to SNMP OCMA 360 (message 704).

Upon receiving this information, interface software 365 in SNMP OCMA 365 marshals this object request into an SNMP PDU, constructs a notification message (or trap) and sends the notification message to SNMP OCMM 330 on management platform 320. Interface software 335 in SNMP OCMM 330 demarshals the SNMP PDU into an object request, locates the original source object in objects 340, and invokes the specified method on the source object specified method with the designated parameter values (message 706). The source object accepts the response and performs any required actions.

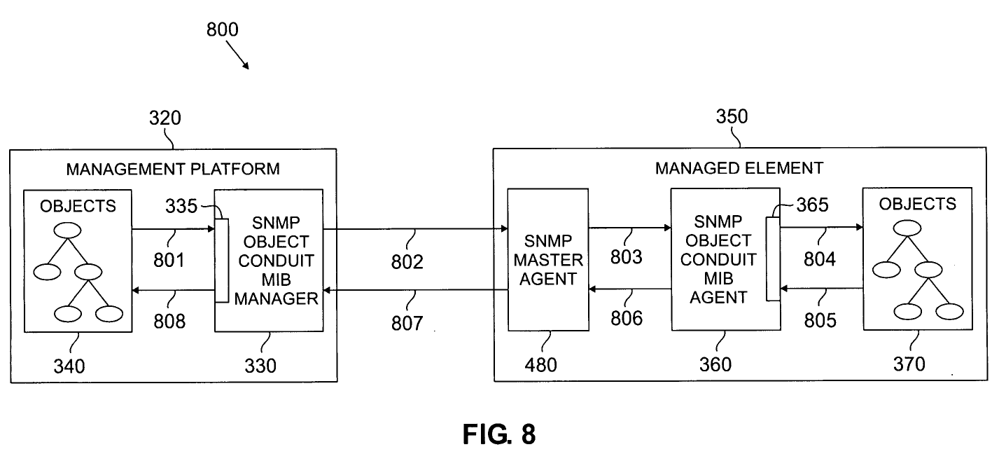

FIG. 8 depicts message flow diagram 800, which illustrates the invocation of a method with response on managed element 350 using SNMP master agent 480 according to the principles of the present invention. Initially, one of objects 340 in management platform 320 (source) attempts to communicate with one of objects 370 in managed element 350 (target). To do this, the object sends target object ID, target method ID, and target parameters to local SNMP object conduit MIB manager (OCMM) 330 (message 801). Interface software 335 in SNMP OCMM 330 marshals the received information request into an SNMP protocol data unit (PDU) and sends an SNMP Set message to SNMP master agent 480 (message 802).

Next, SNMP master agent 480 identifies SNMP object conduit MIB agent (OCMA) 360 as the sub-agent to which this request belongs and forwards the request to SNMP object conduit MIB agent (OCMA) 360 (message 803). Interface controller 365 in SNMP OCMA demarshals the SNMP PDU into an object request, locates the target object in objects 370, and invokes the specified method on the target object with the designated parameter values (message 804). The target object performs the requested action.

In this scenario, the target object sends a response message back to the source object in objects 340. The target object sends the source object ID, response method name, and response parameters to SNMP OCMA 360 (message 805). Upon receiving this information, interface controller 365 in SNMP OCMA 360 marshals this object request into an SNMP PDU, constructs a notification message (or trap) and forwards the notification message to SNMP master agent 480 (message 806).

SNMP master agent 480 forwards the notification message to SNMP OCMM 330 in management platform 320. SNMP OCMM 330 demarshals the SNMP PDU into an object request, locates the original source object in objects 340, and invokes the specified method on the source object with the designated parameter values. The source object accepts the response and performs any required actions.

An object conduit MIB according to the principles of the present invention extends the object-to-object programming paradigm between software running on different machines. Advantageously, the object conduit MIB avoids the use of artificial flags and cumbersome data structures within a conventional MIB in support of operations that typically do not fit the get, set, and trap primitives. The object conduit MIB provides a flexible object interface definition without imposing any undue restrictions and supports dynamic addition of new method invocations on managed element without modifying the MIB structure.

The object conduit MIB according to the principles of the present invention is highly extensible, since it is not sensitive to the content of the information that is being transferred. The exact content of the information that is being passed is not known at the MIB level. The object conduit MIB approach significantly reduces the number of MIB variables required, saves implementation time, and is easily maintainable. Furthermore, the MIB structure is static and need not be discovered by the OCMM.

Although the present invention has been described with an exemplary embodiment, various changes and modifications may be suggested to one skilled in the art. It is intended that the present invention encompass such changes and modifications as fall within the scope of the appended claims.

### Appendix

### MIB Structure

| IP-BSS | DEFINITIONS ::= BEGIN | |
|---|---|---|
| | IMPORTS | |
| | enterprises, | MODULE-IDENTITY, NOTIFICATION-TYPE, |
| | OBJECT-TYPE | |
| | | FROM SNMPv2-SMI |
| | RowStatus | |
| | | FROM SNMPv2-TC; |
| ip-bss | MODULE-IDENTITY | |
| | LAST-UPDATED | “200210131330Z” |
| | ORGANIZATION | “Samsung Telecommunication America” |
| | CONTACT-INFO | “BalaSubrahmanyam Gattu |
| | | email: bgattu@sta.samsung.com |
| | | Phone: 972-761-7477” |
| | DESCRIPTION | “This MIB module defines a Object Conduit MIB which |
| | | can be used for marshaling and demarshaling of |
| | | distributed object communication.” |
| | REVISION | “200210131330Z” |
| | DESCRIPTION | |
| | | “” |

::= { wirelesssystem 19 }

| | |
|---|---|
| org | OBJECT IDENTIFIER |

::= { iso 3 }

| | |
|---|---|
| dod | OBJECT IDENTIFIER |

```
          ::= { org 6 }
internet OBJECT IDENTIFIER
          ::= { dod 1 }
private OBJECT IDENTIFIER
          ::= { internet 4 }
enterprises OBJECT IDENTIFIER
          ::= { private 1 }
samsung OBJECT IDENTIFIER
          ::= { enterprises 236 }
wirelesssystem OBJECT IDENTIFIER
          ::= { samsung 22 }
distributedObjectCommunication OBJECT IDENTIFIER
          ::= { ip-bss 1 }
docDistributedObjectNotifications OBJECT IDENTIFIER
          ::= { distributedObjectCommunication 1 }
docMethodInvocation OBJECT IDENTIFIER
          ::= { distributedObjectCommunication 2 }
docDistributedObjectNotification NOTIFICATION-TYPE
```

| | |
|---|---|
| STATUS | current |
| DESCRIPTION | |

```
              “This notification is used to send response from objects at
              Managed Elements to Management Platform objects. This notification
              can also be used for calling methods on objects at Management
              Platform from the objects at Management Elements.”
          ::= { docDistributedObjectNotifications 1 }
```

| | |
|---|---|
| docMaxMethodInvocation | OBJECT-TYPE |
| SYNTAX | Integer32 |
| MAX-ACCESS | read-write |
| STATUS | current |
| DESCRIPTION | |

```
              “This MIB variable represents max number of method calls possible
              at agent in a given time.”
          ::= { docMethodInvocation 1 }
```

| | |
|---|---|
| docMaxParameters | OBJECT-TYPE |
| SYNTAX | Integer32 |
| MAX-ACCESS | read-write |
| STATUS | current |
| DESCRIPTION | |

```
              “docMaxParameters represents how many max docParameterEntries are
              possible in docParameterTable”
          ::= { docMethodInvocation 2 }
```

| | |
|---|---|
| docMethodInvocationTable | OBJECT-TYPE |
| SYNTAX | SEQUENCE OF DocMethodInvocationEntry |
| MAX-ACCESS | not-accessible |
| STATUS | current |
| DESCRIPTION | |

```
              “This table stores entries of each concurrent method invocation
              call. Once method is forwarded to objects at Managed Elements
              table entry will be cleared for future use.”
          ::= { docMethodInvocation 3 }
```

| | |
|---|---|
| docMethodInvocationEntry | OBJECT-TYPE |
| SYNTAX | DocMethodInvocationEntry |
| MAX-ACCESS | not-accessible |
| STATUS | current |
| DESCRIPTION | |

```
              “Each Entry represents one method call in progress at agent.
              Number of these entries depends on docMaxMethodInvocation value.”
```

| | |
|---|---|
| INDEX | { docMethodInvocationIndex } |
| ::= | { docMethodInvocationTable 1 } |

| | |
|---|---|
| DocMethodInvocationEntry ::= | SEQUENCE { |
| docMethodInvocationIndex | OCTET STRING, |
| docObjectName | OCTET STRING, |
| docMethodName | OCTET STRING, |
| docNumberOfParameters | Integer32 |
| } | |

| | |
|---|---|
| docMethodInvocationIndex | OBJECT-TYPE |
| SYNTAX | OCTET STRING |
| MAX-ACCESS | read-only |
| STATUS | current |
| DESCRIPTION | |

```
              “This is the index in docMethodInvocationEntry. Each object and
              method combination have unique index. This can be integer index or
              objectName + MethodName or whatever both Managed Element and
              Management Station agree and follow.”
          ::= { docMethodInvocationEntry 1 }
```

| | |
|---|---|
| docObjectId | OBJECT-TYPE |
| SYNTAX | OCTET STRING |
| MAX-ACCESS | read-write |
| STATUS | current |
| DESCRIPTION | |

```
              “This field contains the Identifier of the Object at Managed
              Element to call a method.”
          ::= { docMethodInvocationEntry 2 }
```

| | |
|---|---|
| docMethodId | OBJECT-TYPE |
| SYNTAX | OCTET STRING |
| MAX-ACCESS | read-write |
| STATUS | current |
| DESCRIPTION | |

```
              “This is the Identifier of the method on object at Managed Element
              which Management Station object is interested to invoke.”
          ::= { docMethodInvocationEntry 3 }
```

| | |
|---|---|
| docNumberOfParameters | OBJECT-TYPE |
| SYNTAX | Integer32 |
| MAX-ACCESS | read-write |
| STATUS | current |
| DESCRIPTION | |

```
              “Number of Parameters this method needs.”
          ::= { docMethodInvocationEntry 4 }
```

| | |
|---|---|
| docParameterTable | OBJECT-TYPE |
| SYNTAX | SEQUENCE OF DocParameterEntry |
| MAX-ACCESS | not-accessible |
| STATUS | current |
| DESCRIPTION | |

```
              “This table stores all the parameters needed for method
              invocation.”
          ::= { docMethodInvocation 4 }
```

| | |
|---|---|
| docParameterEntry | OBJECT-TYPE |
| SYNTAX | DocParameterEntry |
| MAX-ACCESS | not-accessible |
| STATUS | current |
| DESCRIPTION | |

```
              “Each docParameterEntry represents one parameter. If a given
              method has n parameters then we need n entries in this table.”
```

| | |
|---|---|
| INDEX | { docMethodInvocationIndex, |
| | docParameterIndex } |
| ::= | { docParameterTable 1 } |

| | |
|---|---|
| DocParameterEntry ::= | SEQUENCE { |
| docParameterIndex | OCTET STRING, |
| docParameterType | Integer32, |
| docParameterLength | Integer32, |
| docParameterValue | OCTET STRING |
| } | |

| | |
|---|---|
| docParameterIndex | OBJECT-TYPE |
| SYNTAX | OCTET STRING |
| MAX-ACCESS | read-write |
| STATUS | current |
| DESCRIPTION | |

```
          “Index of docParameterTable”
          ::= { docParameterEntry 1 }
```

| | |
|---|---|
| docParameterType | OBJECT-TYPE |
| SYNTAX | Integer32 |
| MAX-ACCESS | read-write |
| STATUS | current |
| DESCRIPTION | |

```
              “This column represents the type of the parameter. Depending on
              the project we can assign predefined types like 1-int, 2-long, 3-
              char, 4-boolean etc.”
          ::= { docParameterEntry 2 }
```

| | |
|---|---|
| docParameterLength | OBJECT-TYPE |
| SYNTAX | Integer32 ( −2147483648 .. 2147483647 ) |
| MAX-ACCESS | read-write |
| STATUS | current |
| DESCRIPTION | |

```
              “Length of the parameter. Length depends on the docParameterType.
              This value useful for some of the datatypes. For data types like
              char etc we know the length. For strings this Length needs to be
              present.”
          ::= { docParameterEntry 3 }
```

| | |
|---|---|
| docParameterValue | OBJECT-TYPE |
| SYNTAX | OCTET STRING |
| MAX-ACCESS | read-write |
| STATUS | current |
| DESCRIPTION | |

```
              “Value of the parameter.”
          ::= { docParameterEntry 4 }
END
```

1. For use in a communication network, a first object-oriented telecommunication device capable of communicating with a second object-oriented telecommunication device in said communication network, said first object-oriented telecommunication device comprising:
a plurality of objects executable by processing circuitry associated with said first object-oriented telecommunication device; and
an object conduit management information base (MIB) manager capable of gathering data from one or more of said plurality of objects and generating therefrom a management information base (MIB) data structure suitable for communicating with said second object-oriented telecommunication device using a specified protocol interface.

2. The first object-oriented telecommunication device as set forth in claim 1 wherein said specified protocol interface is Simple Network Management Protocol (SNMP).

3. The first object-oriented telecommunication device as set forth in claim 1 wherein said MIB data structure comprises an object identifier (ID) associated with a target object in said second object-oriented telecommunication device.

4. The first object-oriented telecommunication device as set forth in claim 3 wherein said MIB data structure comprises a target method 1D identifying a selected method associated with said target object and at least one method parameter associated with said selected method.

5. The first object-oriented telecommunication device as set forth in claim 4 wherein said object conduit MIB manager comprises an interface controller capable of communicating with said one or more of said plurality of objects and gathering said data from said one or more of said plurality of objects.

6. The first object-oriented telecommunication device as set forth in claim 1 wherein said object conduit management information base (MIB) manager is further capable of receiving a response MIB data structure from said second object-oriented telecommunication device, extracting data from said response MIB data structure, and distributing said extracted data to said one or more of said plurality of objects.

7. For use in a communication network, a first object-oriented telecommunication device capable of communicating with a second object-oriented telecommunication device in said communication network, said first object-oriented telecommunication device comprising:
a plurality of objects executable by processing circuitry associated with said first object-oriented telecommunication device; and
an object conduit management information base (MIB) agent capable of receiving a management information base (MIB) data structure from said second object-oriented telecommunication device using a specified protocol interface, extracting data from said received MIB data structure, and distributing said extracted data to one or more of said plurality of objects.

8. The first object-oriented telecommunication device as set forth in claim 7 wherein said specified protocol interface is Simple Network Management Protocol (SNMP).

9. The first object-oriented telecommunication device as set forth in claim 7 wherein said MIB data structure comprises an object identifier (ID) associated with a target one of said one or more of said plurality of obj ects in said first object-oriented telecommunication device.

10. The first object-oriented telecommunication device as set forth in claim 9 wherein said MIB data structure comprises a target method ID identifying a selected method associated with said target object and at least one method parameter associated with said selected method.

11. The first object-oriented telecommunication device as set forth in claim 10 wherein said object conduit MIB agent comprises an interface controller capable of communicating with said one or more of said plurality of objects and distributing said extracted data to said one or more of said plurality of objects.

12. The first object-oriented telecommunication device as set forth in claim 7 wherein said object conduit MIB agent is further capable of gathering data from said one or more of said plurality of objects and generating therefrom a response management information base (MIB) data structure suitable for communicating with said second object-oriented telecommunication device using said specified protocol interface.

13. A communication network comprising:
a first object-oriented telecommunication device capable of communicating with a second object-oriented telecommunication device in said communication network, said first object-oriented telecommunication device comprising:
a plurality of objects executable by processing circuitry associated with said first object-oriented telecommunication device; and
an object conduit management information base (MB) manager capable of gathering data from one or more of said plurality of objects and generating therefrom a management information base (MIB) data structure suitable for communicating with said second object-oriented telecommunication device using a specified protocol interface.

14. The communication network as set forth in claim 13 wherein said specified protocol interface is Simple Network Management Protocol (SNMP).

15. The communication network as set forth in claim 13 wherein said MIB data structure comprises an object identifier (ID) associated with a target object in said second object-oriented telecommunication device.

16. The communication network as set forth in claim 15 wherein said MIB data structure comprises a target method ID identifying a selected method associated with said target object and at least one method parameter associated with said selected method.

17. The communication network as set forth in claim 16 wherein said object conduit MIB manager comprises an interface controller capable of communicating with said one or more of said plurality of objects and gathering said data from said one or more of said plurality of objects.

18. The communication network as set forth in claim 13 wherein said object conduit management information base (MIB) manager is further capable of receiving a response MIB data structure from said second object-oriented telecommunication device, extracting data from said response MIB data structure, and distributing said extracted data to said one or more of said plurality of objects.

19. The communication network as set forth in claim 13 wherein said second object-oriented telecommunication device comprises:
a plurality of objects executable by processing circuitry associated with said second object-oriented telecommunication device; and
an object conduit management information base (MIB) agent capable of receiving said management information base (MIB) data structure from said first object-oriented telecommunication device, extracting data from said received MIB data structure, and distributing said extracted data to one or more of said plurality of objects.

20. The communication network as set forth in claim 19 wherein said specified protocol interface is Simple Network Management Protocol (SNMP).

21. The communication network as set forth in claim 19 wherein said MIB data structure comprises an object identifier (ID) associated with a target one of said one or more of said plurality of objects in said first object-oriented telecommunication device.

22. The communication network device as set forth in claim 21 wherein said MIB data structure comprises a target method ID identifying a selected method associated with said target object and at least one method parameter associated with said selected method.

23. The communication network as set forth in claim 22 wherein said object conduit MIB agent comprises an interface controller capable of communicating with said one or more of said plurality of objects and distributing said extracted data to said one or more of said plurality of objects.

24. The communication network as set forth in claim 19 wherein said object conduit MIB agent is further capable of gathering data from said one or more of said plurality of objects in said second object-oriented telecommunication devices and generating therefrom a response management information base (MIB) data structure suitable for communicating with said first object-oriented telecommunication device using said specified protocol interface
